(19) United States
(12) Patent Application Publication
(10) Pub. No.: US 2014/0359770 A1
(43) Pub. Date: Dec. 4, 2014

(54) APPARATUS AND METHODS FOR PREVENTING PAYMENT WEBPAGE TAMPERING

(71) Applicants: Jie Lin, Shenzhen (CN); Wusan Ban, Shenzhen (CN); Qiyuan Meng, Shenzhen (CN)

(72) Inventors: Jie Lin, Shenzhen (CN); Wusan Ban, Shenzhen (CN); Qiyuan Meng, Shenzhen (CN)

(73) Assignee: TENCENT TECHNOLOGY (SHENZHEN) COMPANY LIMITED, Shenzhen, Guangdong (CN)

(21) Appl. No.: 14/345,056

(22) PCT Filed: Sep. 14, 2012
(86) PCT No.: PCT/CN2012/081385

§ 371 Date: Mar. 14, 2014

(30) Foreign Application Priority Data
Sep. 16, 2011 (CN) 201110277604.7

(51) Int. Cl. H04L 29/06

(52) U.S. Cl. CPC H04L 63/1466
USPC 726/23

(57) ABSTRACT

Apparatus and method for preventing payment page tampering are described herein that determine whether a request received by a webpage modification interface is an inter-process request made by another process different from a process running the webpage modification interface and that, in response to determining that the first request is an external request, intercepts the first request. Embodiments of the apparatus and method can improve security of Internet payment transactions.

### CROSS-REFERENCE TO RELATED APPLICATIONS

This application is a U.S. National Phase application under 35 U.S.C. §371 of International Application No. PCT/CN2012/081385, filed on Sep. 14, 2012, which claims priority to a Chinese Patent Application No. 201110277604.7, filed on Sep. 16, 2011, which are hereby incorporated by reference in their entireties.

### FIELD

The present disclosure relates to Internet technologies, and to a method and apparatus for preventing payment webpage tampering on the Internet.

### BACKGROUND

As Internet technologies continue to evolve, electronic commerce (or e-commerce) has become a very important part of the Internet. However, safety and security issues in e-commerce have restrained the Internet technologies from further rapid development and deployment. By way of non-limiting example, when a user makes an online payment through a browser payment webpage, the payment webpage may be tampered by malicious programs such as a Trojan program, and the user's payment may be directed to an illegitimate party, causing the user to suffer economic losses.

FIG. 1 shows an exemplary webpage that enables a user to execute a financial transaction via online banking. FIG. 2 shows an exemplary webpage that enables a user to confirm a payment via online banking. During the webpage transactions, a Trojan program may intervene and tamper with the payment webpages behind the scene and redirect the user's payment request to tampered, illegitimate payment webpages. The user's payment is thus paid to the illegitimate party through the payment webpage tampered by the Trojan program.

Therefore, a heretofore unaddressed need exists in the art to address the aforementioned deficiencies and inadequacies.

### SUMMARY

Various aspects of the present disclosure are directed to a method for preventing payment page tampering. The method includes determining whether a first request received by a webpage modification interface is an external request, the external request being a inter-process request made by a second process different from a first process running the webpage modification interface, the first process being executed by a processor; and in response to determining that the first request is an external request, intercepting the first request.

Various aspects of the present disclosure are directed to an apparatus for preventing payment page tampering. The apparatus includes a modification interface detector to determine whether a first request received by a webpage modification interface is an external request, the external request being a inter-process request made by a second process different from a first process running the webpage modification interface; and a request interceptor to, in response to determining that the first request is an external request, intercept the first request.

Various aspects of the present disclosure are directed to a computer-readable medium storing instructions which, when executed by a processor, cause a computer to perform a method for preventing payment page tampering. The method includes determining whether a first request received by a webpage modification interface is an external request, the external request being an inter-process request made by a second process different from a first process running the webpage modification interface; and in response to determining that the first request is an external request, intercepting the first request.

Further areas of applicability of the present disclosure will become apparent from the detailed description provided hereinafter. It should be understood that the detailed description and specific non-limiting examples are intended for purposes of illustration only and are not intended to limit the scope of the disclosure.

### BRIEF DESCRIPTION OF THE DRAWINGS

The accompanying drawings illustrate various embodiments and, together with the written description, serve to explain the principles of the disclosure. Wherever possible, the same reference numbers are used throughout the drawings to refer to the same or like procedures of an embodiment. The drawings do not limit the present disclosure to the specific embodiments disclosed and described herein. The drawings are not necessarily to scale, emphasis instead being placed upon clearly illustrating the principles of the disclosure. The present disclosure will become more fully understood from the detailed description and the accompanying drawings, wherein:

FIG. 1 shows an exemplary webpage that enables a user to execute a financial transaction via online banking;

FIG. 2 shows an exemplary webpage that enables a user to confirm a payment via online banking;

FIG. 3 is a flow chart showing a protection procedure according to various embodiments;

FIG. 4 is a flow chart showing the protection procedure according to various embodiments;

FIG. 5 is a block diagram showing an apparatus running the protection procedure according to various embodiments; and

FIG. 6 is a block diagram showing a request interceptor of the apparatus in FIG. 5 according to various embodiments.

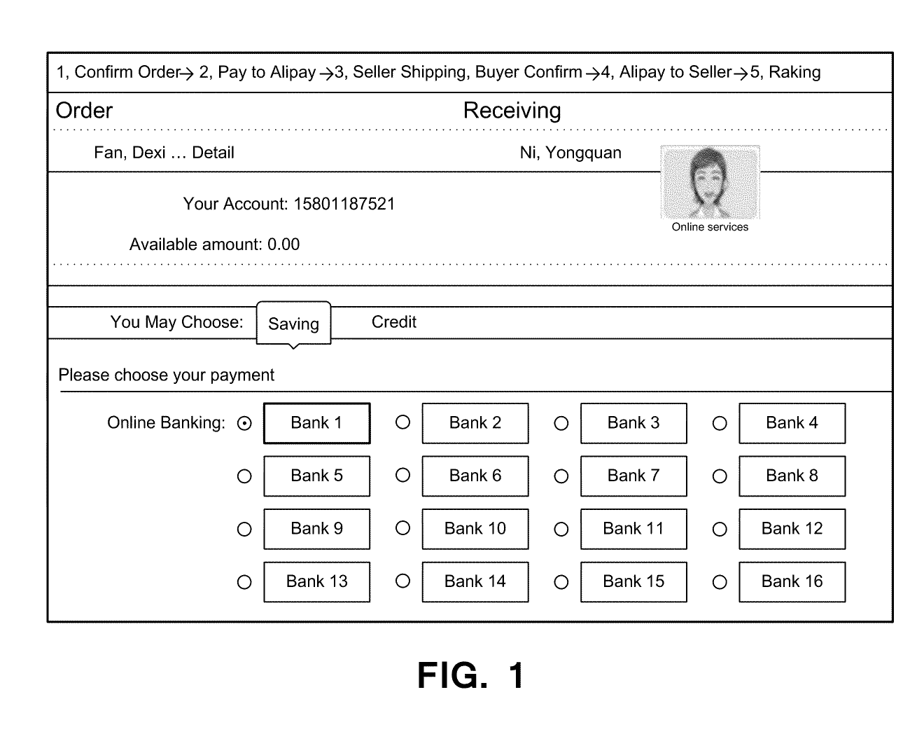

### DETAILED DESCRIPTION

The following description is merely illustrative in nature and is not intended to limit the disclosure, its application, or uses. The broad teachings of the disclosure can be implemented in a variety of forms. Therefore, while this disclosure includes particular embodiments, the scope of the disclosure should not be so limited since other modifications will become apparent upon a study of the drawings, the specification, and the following claims. For purposes of clarity, the same reference numbers will be used in the drawings to identify similar procedures or components. As used herein, the phrase at least one of A, B, and C should be construed to mean a logical (A or B or C), using a non-exclusive logical OR. It should be understood that one or more steps within a method may be executed in a different order (or concurrently) without altering the principles of the present disclosure.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. The use of embodiments anywhere in this specification, including non-limiting examples of any terms discussed herein, is illustrative only, and in no way limits the scope and meaning of the disclosure or of any exemplified term. Likewise, the disclosure is not limited to various embodiments given in this specification.

As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise.

As used herein, the terms “comprising,” “including,” “having,” “containing,” “involving,” and the like are to be understood to be open-ended, i.e., to mean including but not limited to.

As used herein, the term module or unit may refer to, be part of, or include an Application Specific Integrated Circuit (ASIC); an electronic circuit; a combinational logic circuit; a field programmable gate array (FPGA); a processor (shared, dedicated, or group) that executes code; other suitable hardware components that provide the described functionality; or a combination of some or all of the above, such as in a system-on-chip. The term module may include memory (shared, dedicated, or group) that stores code executed by the processor.

The term code, as used above, may include software, firmware, and/or microcode, and may refer to programs, routines, functions, classes, and/or objects. The term shared, as used above, means that some or all code from multiple modules may be executed using a single (shared) processor. In addition, some or all code from multiple modules may be stored by a single (shared) memory. The term group, as used above, means that some or all code from a single module may be executed using a group of processors. In addition, some or all code from a single module may be stored using a group of memories.

The apparatuses and methods described herein may be implemented by one or more computer programs executed by one or more processors. The computer programs include processor-executable instructions that are stored on a non-transitory tangible computer readable medium. The computer programs may also include stored data. Non-limiting embodiments of the non-transitory tangible computer readable medium are nonvolatile memory, magnetic storage, and optical storage.

In modern computer technologies, a browser may be a component supported by a platform of an operation system. By way of non-limiting example, a MICROSOFT INTERNET EXPLORER is a component supported by the MICROSOFT Component Object Model (COM) platform. A user process may create an INTERNET EXPLORER object through COM APIs (Application Programming Interfaces) and libraries. COM platform provides a communication mechanism, by making use of connection points and sinks, to support communication between a COM client and a COM server. By way of non-limiting example, the COM client passes a connection point to the COM server. The COM server, upon occurrence of certain events, can use the connection point to pass messages to a sink of the COM client.

A Trojan program typically is malicious code designed primarily to give a hacker access to system files of a user's computer. This gives hackers the ability to change file settings, steal files or passwords, damage files, monitor user activities, or execute processes that are not authorized by the user on the user's computer.

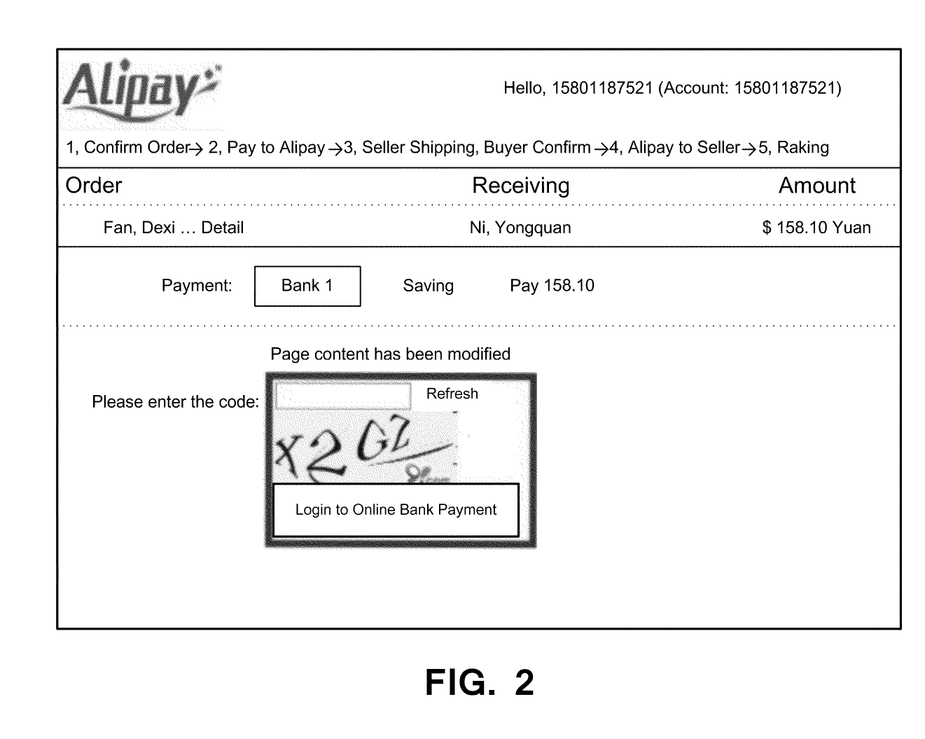

Generally, when a Trojan program attempts to modify a payment page rendered by a browser (or similarly other application program capable of rendering webpage), the Trojan program will go through the following three steps: (a) registering the Trojan program for receiving events of or callbacks from the browser rendering the payment page, (b) determining whether a page rendered by the browser is a target payment page that the Trojan program intends to modify, and (c) modifying the payment page identified in (b). A payment page refers to a graphic display rendered by an application program (e.g., a webpage rendered by a browser) that is used by a user in execution of an online financial transaction. By way of non-limiting example, the webpage shown in FIG. 2 is a payment page and it enables a user of the browser to transfer funds from the user's account to another party. Non-limiting examples of browsers may include any browser executable on a user terminal such as a desktop or a mobile device, for instance, a MICROSOFT INTERNET EXPLORE browser, a FIREFOX browser, a QQ browser, a Chrome browser, or a Safari browser.

Depending on the circumstances, the below description may use MICROSOFT INTERNET EXPLORER browser as a non-limiting example to explain the techniques or features of the present disclosure. One skilled in the art would recognize that those techniques or features can be similarly applied to other browser applications or User Interface applications. When a user uses an INTERNET EXPLORER browser to browse the Internet, a Trojan program installed on the computer can monitor the Uniform Resource Locator (URL) of the webpage that the user is accessing through the INTERNET EXPLORER browser. The Trojan program can receive URLs, by way of non-limiting example, through a BeforeNavigate2 event generated by the INTERNET EXPLORER browser. The Trojan program then compares the URL of the current webpage rendered by the INTERNET EXPLORER browser or the URLs contained in the current webpage with a table or list of known payment webpage URLs. If the current URLs match a known payment page URL in the table or list, the Trojan program can attempt to modify the webpage through the Write function of the IHTMLDocument 2 interface, displaying at the INTERNET EXPLORER browser a tampered webpage that redirects the payment from the user to an illegitimate party provided by the Trojan program.

In tampering a payment page, the Trojan program typically utilizes the following interfaces: (a) a callback registration interface through which a program can register itself to receive events raised by a browser that relate to browser navigation, (b) a browser object interface through which a program can access the properties and functions of the browser, and (c) an HTML modification interface through which a program can access a particular webpage rendered by the browser and modify the content of the webpage. These interfaces, through which access and modification to a particular webpage may be performed, can be collectively referred to as webpage modification interfaces.

A Trojan program typically runs on a separate (or different) process from browser processes. A request from the Trojan process made to the browser process is thus typically an inter-process request or an external request. Various embodiments monitor inter-process requests or external requests for accessing the browser process. It may not be necessary to identify the source of the external request, i.e., to determine if the request is from the Trojan process. All external requests or inter-process requests for accessing the browser process can be intercepted.

Various embodiments implement a protection procedure that prevents a Trojan program from tampering a payment page (e.g., an online banking webpage) rendered by a browser. In order to determine whether an inter-process call has been made to the browser process, the protection procedure can initially determine whether the call stack of a program implementing the webpage modification interface described above contains a file, procedure, routine, or any program that implements or relates to a remote procedure call (RPC). If the call stack of such a program contains a RPC call related file, the protection procedure can determine that an inter-process request for accessing the webpage modification interface has occurred. By way of non-limiting example, in a COM environment, the protection procedure determines whether a RPCRT4.dll file exists in one or more of the call stacks of a container interface of a container supporting a browser object, a browser object interface, and a HTML modification interface through which a program can modify a particular HTML webpage of the browser. More particularly, these call stacks may include the call stacks of programs implementing the IHTMLDocument2, IConnectionPointContainer or IConnection Point, and IWebBrowser2 interfaces. By way of non-limiting example, a single webpage display of the browser may implement the IHTMLDocument2 interface; a COM container module may implement the IConnectionPointContainer interface; a COM connection point module may implement the IConnectionPoint interface; and an INTERNET EXPLORER browser may implement the IWebBrowser2 interface. By way of non-limiting example, if the RPCRT4.dll file exists in one or more of these call stacks, it can be determined that the received request made to the above described container interface, the browser object interface, or the HTML modification interface is an external or inter-process request.

There are many types of external or inter-process requests. By way of non-limiting example, in order to tamper a payment page in a COM environment, a Trojan program typically needs to access: (a) a function of the callback registration interface that allows the Trojan program to register itself to receive events or callbacks from the browser; (b) a local URL obtainment function of the browser object interface that returns the URL of the webpage currently being rendered by the browser; and (c) a function of the HTML modification interface that is used to provide the content of the page being rendered by the browser. Some non-limiting examples of these functions include the Advise function of the IConnection Point interface, the GetLocationURL function of the IWebBrowser2 interface, and the Write function of the IHTMLDocument2 interface.

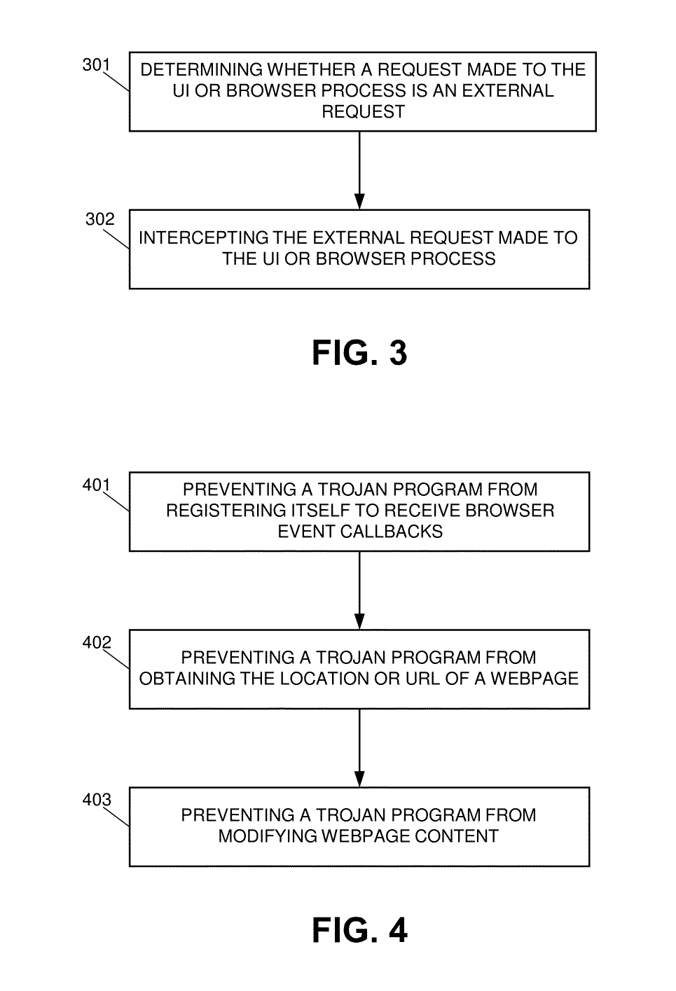

FIG. 3 is a flow chart showing a protection procedure in accordance with various embodiments. At operation 301, the protection procedure determines whether the request made to the browser process is an external request. At operation 302, the protection procedure intercepts the external request made to the browser process. The external request can be an inter-process request sent by a process different from those of the browser.

A browser can render various webpages. The protection procedure may be adapted to protect various types of webpages rendered by the browser. In various embodiments, the protection procedure concerns preventing unauthorized payment through tampered payment webpages. If the protection procedure determines that the current webpage rendered by the browser is not a payment webpage or that the external requests received is not related to any payment webpage, the protection procedure can choose not to intercept those external requests.

As such, at the operation 301, the protection procedure can also determine whether the webpage rendered by the browser is a payment webpage.

In various embodiments, the protection procedure examines the URL of a webpage to determine whether the webpage is a payment page. The URLs of known payment pages can be stored as a table or a list on the local computer running the protection procedure or on a network storage device. As an illustration, the following URL is a URL of a payment webpage. The URL is: <https://netpay.cmbchina.com/netpayment/BaseHttp.dll>. This payment webpage also contains payment URL links such as:

<rule host=“https://netpay.cmbchina.com” path=“/netpayment/BaseHttp.dll? PrePayC*” level=“3”/>.

The protection procedure can, in order to determine whether the webpage is a payment page, compare the above-mentioned URL of the webpage and the links contained in the webpage with the stored URLs and/or determine whether the URL and links contain the defining characteristics of payment page. The defining characteristics can be predetermined and stored in the URL table or list of the computer system.

FIG. 4 is a flow chart showing the protection procedure according to various embodiments. In order to prevent payment webpage tampering, one or more of following operations can be taken: operation 401 for preventing a Trojan program from registering itself to receive browser event callbacks; operation 402 for preventing a Trojan program from obtaining the location or the URL of a webpage; and operation 403 for preventing a Trojan program from modifying webpage content.

In various embodiments, operation 403 can be combined with operation 401 and operation 402. These operations are not necessarily executed in the above listed sequences.

In various embodiments, operation 401 can prevent malicious programs such as a Trojan program from obtaining information of the browser or calling functions of the browser. In order to monitor the browser's events, the Trojan program typically needs to call the callback registration interface to register itself to receive browser events. By way of non-limiting example, in a COM environment, the Trojan program needs to call the Advise functions of connection point objects implementing the IConnectionPoint interface held by the browser objects or browser helper objects in order to signal that the Trojan program is interested in receiving callbacks or events of the browser. If calls made to the callback registration interface are intercepted, then the Trojan program will not be able to obtain the browser event information. Without the browser event information, the Trojan program will not be able to modify the webpage.

Operation 402 can prevent a malicious program such as the Trojan program from obtaining the location or the URL of the page rendered by the browser (e.g., the local URL shown in the address bar of the browser). Normally the Trojan program needs to have this URL to determine whether the page being rendered by the browser is a payment page. The Trojan program often receives multiple URLs from a browser event callback. By way of non-limiting example, if a webpage contains frames, the Trojan program will receive multiple URLs from the browser event. The Trojan program must call a function of the browser object interface to obtain the URL of the page currently being rendered by the browser, and use the URL to determine whether the current page is a payment page. In a COM environment, the Trojan program calls the GetLocationURL function of the IWebBrowser2 interface to obtain this URL. At operation 402, the protection procedure intercepts calls made by the Trojan program to such a function of the browser object interface. Thus, the Trojan program will not be able to determine whether the current page is a payment page based on the URL of the page.

Operation 403 can prevent a malicious program such as a Trojan program from modifying the content of a webpage. The Trojan program eventually needs to call a HTML modification interface in order to modify the payment page being rendered by the browser. In a COM environment, the Trojan program calls the Write function of the IHTMLDocument2 interface to modify the webpage content. At operation 403, the protection procedure can intercept calls made by the Trojan program to such a function of the HTML modification interface. Thus, the protection procedure prevents the Trojan program from modifying the content of the page rendered by the browser.

In various embodiments, when executing one or more of operations 401-403, as discussed above, the protection procedure can also determine whether the current request is an inter-process or external request. In a COM environment, the protection procedure checks the call stacks of programs implementing the IHTMLDocument2, IConnection PointContainer, IConnectionPoint, and IWebBrowser2 interfaces. Usually, if these call stacks contain an RPC related file such as RPCRT4.dll, the protection procedure can determine that a current request made to the above interfaces is an inter-process or external request. Intercepting this inter-process or external request can prevent the Trojan program from accessing the above described container interface, the browser object interface, and the HTML modification interface.

The protection procedure can be implemented on the same computer on which the browser is running. The protection procedure can run on a process executed by a processor (e.g., a CPU) of the computer. The process of the protection procedure can be the same as the browser process. By way of non-limiting example, the protection procedure can be implemented as a plug-in program for the browser. The process of the protection procedure can alternatively be a stand-alone and separate process from the browser process.

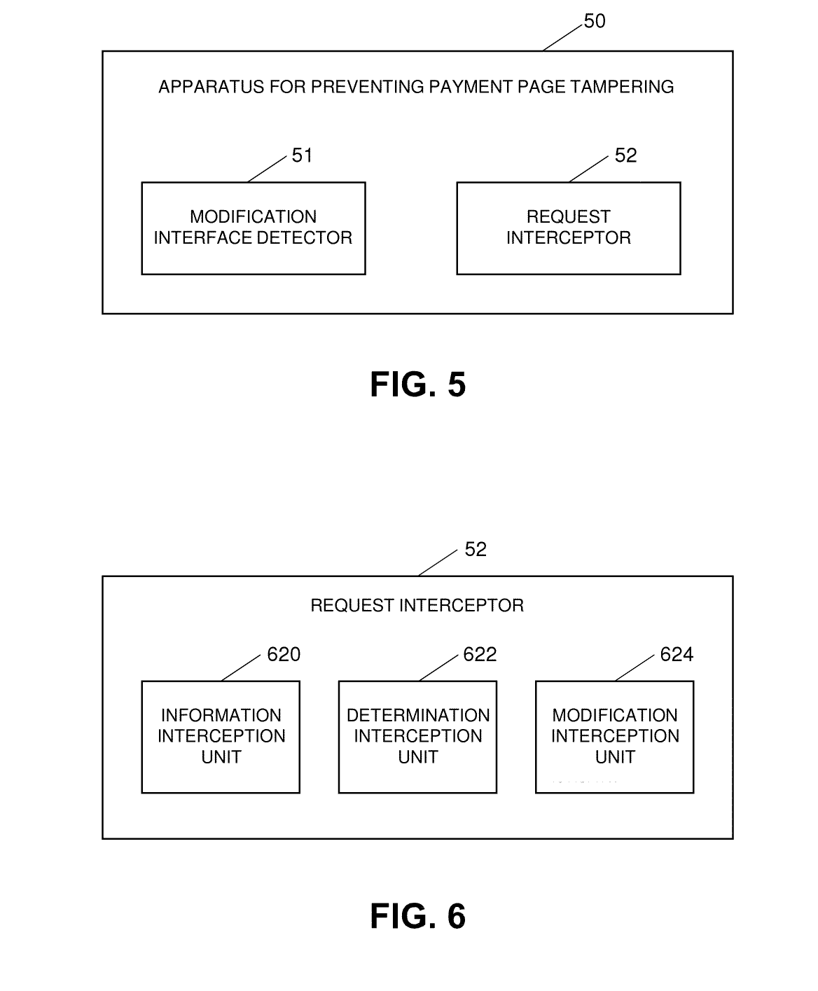

FIG. 5 is a block diagram showing an apparatus running the protection procedure according to various embodiments. The apparatus 50 includes: (a) a modification interface detector 51 to detect whether a request or call received by the webpage modification interface is an external request, and (b) a request interceptor 52 to intercept the external request when the external request is detected by the modification interface detector 51. The external request can be an inter-process request from a process different from a webpage process currently running. The modification interface detector 51 and the request interceptor 52 can be physical and/or logical modules that employ or utilize necessary hardware (e.g., a processor and a memory) and software to implement the desired features.

The webpage modification interface includes the callback registration interface for a program to register itself to receive callbacks or notifications of browser events relating to modifying a payment page, the browser object interface, and one or more of the HTML modification interfaces. The above described external request accordingly includes calls made to the advise function of the callback registration interface, the local URL obtainment function of the browser object interface, and one or more of the write functions of the HTML modification interface. The advise function of the callback registration interface allows a program to register itself to receive events or callbacks from the browser. The local URL obtainment function of the browser object interface allows a program to retrieve the URL of the webpage that the browser object is currently rendering, which is generally the URL shown in the address bar of the browser. The write functions of the HTML modification interface allows a program to provide the content that is to be rendered by the browser. In a COM environment, a non-limiting example of the advise function of the callback registration interface is the Advise function of the IConnectionPoint interface. A non-limiting example of the local URL obtainment function is the GetLocationURL function of the IWebBrowser2 interface. A non-limiting example of the write functions of the HTML modification interface is the Write function of the IHTMLDocument2 interface.

In various embodiments, the modification interface detector 51 can be also used to determine whether the call stack of a process running the webpage modification interface contains a RPC related file (such as RT4.dll file). When the modification interface detector 51 determines that the call stack contains such a file, then it determines that the webpage modification interface has received an external request. The modification interface detector 51 can also be used to determine whether the current page rendered by the browser is a payment page.

FIG. 6 is a block diagram showing a request interceptor 52 of the apparatus according to various embodiments. The request interceptor 52 can include at least one of: (a) an information interception unit 620 to intercept calls or requests from another process made to the advise function of the callback registration interface (such as the Advise function of the IConnectionPoint interface) in order to obtain browser information; (b) a determination interception unit 622 to intercept calls or requests from another process made to the local URL obtainment function of the browser object interface (such as the GetLocationURL function of the IWebBrowser2 interface) in order to determine if the current page is a payment page; and (c) a modification interception unit 624 to intercept calls or requests from another process made to the write function of the HTML modification interface (such as the Write function of the IHTMLDocument2 interface) in order to modify the content of a payment page.

Various embodiments can effectively prevent payment webpage tampering by a Trojan program. By way of non-limiting example, external requests from a malicious program such as a Trojan program that attempts to tamper a payment webpage can be distinguished, detected and intercepted by various embodiments. Various embodiments can improve the safety and security of online banking and electronic payment transactions.

As it is understood by the one skilled in the art, part or all of the features of the present disclosure can be implemented by computer programs executed by related computer hardware including a processor. The present disclosure can be stored in a computer readable/writable medium, which includes magnetic disk, CD/DVD, Read-Only Memery or ROM, and Random Access Memory or RAM.

The foregoing description of the various embodiments has been presented only for the purposes of illustration and description and is not intended to be exhaustive or to limit the disclosure to the precise forms disclosed. Many modifications and variations are possible in light of the above teaching.

Various embodiments were chosen and described in order to explain the principles of the disclosure and their practical application so as to activate others skilled in the art to utilize the disclosure and various embodiments and with various modifications as are suited to the particular use contemplated. Alternative embodiments will become apparent to one skilled in the art to which the present disclosure pertains without departing from its spirit and scope. Accordingly, the scope of the present disclosure is defined by the appended claims rather than the foregoing description and the various embodiments described therein.

1. A method for preventing webpage tampering, comprising:
determining whether a first request received by a webpage modification interface is an external request, the external request being an inter-process request made by a second process different from a first process running the webpage modification interface, the first process being executed by a processor; and
in response to determining that the first request is an external request, intercepting the first request.

2. The method of claim 1, wherein the webpage modification interface comprises at least one of a callback registration interface that allows a program to register for receiving callbacks or events from a browser and relating to modifying a webpage, a browser object interface, and one or more HTML modification interfaces.

3. The method of claim 2, wherein the external request comprises a request made to an advise function of the callback registration interface, a local URL obtainment function of the browser object interface, or one or more write functions of at least one of the HTML modification interfaces,
wherein the advise function of the callback registration interface allows a program to register for receiving the callbacks or events from the browser, the local URL obtainment function of the browser object interface allows a program to retrieve the URL of a webpage that the browser is currently rendering, and the one or more write functions of the at least one HTML modification interface allows a program to provide to the browser a content to be rendered.

4. The method of claim 3, wherein the advise function of the callback registration interface comprises an Advise function of an IConnectionPoint interface, the local URL obtainment function of the browser object interface comprises a GetLocationURL function of an IWebBrowser2 interface, and the one or more write functions of the at least one HTML modification interface comprises a Write function of an IHTMLDocument2.

5. The method of claim 3, wherein the intercepting the first request comprises at least one of
intercepting a call made from the second process to the advise function of the callback registration interface to obtain browser information;
intercepting a call made from the second process to the local URL obtainment function of the browser object interface to determine whether a page currently being rendered by a browser is a payment page; and
intercepting a call made from the second process to at least one of the write functions of the at least one HTML modification interface to modify a content of a payment page.

6. The method of claim 1, wherein the determining whether the first request received by the webpage modification interface is an external request comprises
determining whether a call stack of the webpage modification interface contains a remote call procedure (RPC) related file; and
determining, in response to determining that the call stack contains a RPC related file, that the first request received by the webpage modification interface is an external request.

7. The method of claim 6, wherein the RPC related file include RPCRT4.dll file.

8. The method of claim 1, further comprising determining whether a page currently being rendered by a browser is a payment page by comparing a URL of the page to predetermined defining characteristics of payment webpage URLs.

9. An apparatus for preventing payment page tampering, comprising:
a modification interface detector configured to determine whether a first request received by a webpage modification interface is an external request, the external request being an inter-process request made by a second process different from a first process running the webpage modification interface; and
a request interceptor configured to, in response to determining that the first request is an external request, intercept the first request.

10. The apparatus of claim 9, wherein the webpage modification interface comprises a callback registration interface that is configured to allow a program to register for receiving callbacks or events from a browser and relating to modifying a payment page, a browser object interface, and one or more HTML modification interfaces, and
wherein the external request comprises a request made to an advise function of the callback registration interface, a local URL obtainment function of the browser object interface, or one or more write functions of at least one of the HTML modification interfaces,
wherein the advise function of the callback registration interface is configured to allow a program to register for receiving the callbacks or events from the browser, the local URL obtainment function of the browser object interface is configured to allow a program to retrieve the URL of a webpage that the browser is currently rendering, and the one or more write functions of the at least one HTML modification interface is configured to allow a program to provide to the browser a content to be rendered.

11. The apparatus of claim 10, wherein the advise function of the callback registration interface comprises an Advise function of an IConnectionPoint interface, the local URL obtainment function of the browser object interface comprises a GetLocationURL function of an IWebBrowser2 interface, and the one or more write functions of the at least one HTML modification interface comprises a Write function of an IHTMLDocument2.

12. The apparatus of claim 10, wherein the request interceptor comprises:
an information interception unit configured to intercept a call made from the second process to the advise function of the callback registration interface to obtain browser information;
a determination interception unit configured to intercept a call made from the second process to the local URL obtainment function of the browser object interface to determine whether a page currently being rendered by a browser is a payment page; and
a modification interception unit configured to intercept a call made from the second process to at least one of the write functions of the at least one HTML modification interface to modify a content of a payment page.

13. The apparatus of claim 9, wherein the modification interface detector is further configured to
determine whether a call stack of the webpage modification interface contains an RPCRT4.dll file, and
determine, in response to determining that the call stack contains a RPCRT4.dll file, that the first request received by the webpage modification interface is an external request.

14. The apparatus of claim 9, wherein the modification interface detector is further configured to determine whether a page currently being rendered by a browser is a payment page by comparing a URL of the page to predetermined defining characteristics of payment webpage URLs.

15. A computer-readable medium storing instructions which, when executed by a processor, cause a computer to perform a method for preventing payment page tampering, the method comprising:
determining whether a first request received by a webpage modification interface is an external request, the external request being an inter-process request made by a second process different from a first process running the webpage modification interface; and
in response to determining that the first request is an external request, intercepting the first request.

16. The computer-readable medium of claim 15, wherein the webpage modification interface comprises a callback registration interface that allows a program to register for receiving callbacks or events from a browser and relating to modifying a payment page, a browser object interface, and one or more HTML modification interfaces,
wherein the external request comprises a request made to an advise function of the callback registration interface, a local URL obtainment function of the browser object interface, or one or more write functions of at least one of the HTM modification interfaces,
wherein the advise function of the callback registration interface allows a program to register for receiving the callbacks or events from the browser, wherein the local URL obtainment function of the browser object interface allows a program to retrieve the URL of a webpage that the browser is currently rendering, and the one or more write functions of the at least one HTML modification interface allows a program to provide to the browser a content to be rendered, and
wherein the intercepting the first request includes at least one of
intercepting a call made from the second process to the advise function of the callback registration interface to obtain browser information;
intercepting a call made from the second process to the local URL obtainment function of the browser object interface to determine whether a page currently being rendered by a browser is a payment page; and
intercepting a call made from the second process to at least one of the write functions of the at least one HTML modification interface to modify a content of a payment page.

17. The computer-readable medium of claim 16, wherein the advise function of the callback registration interface comprises an Advise function of an IConnectionPoint interface, the local URL obtainment function of the browser object interface comprises a GetLocationURL function of an IWebBrowser2 interface, and the one or more write functions of the at least one HTML modification interface comprises a Write function of an IHTMLDocument2.

18. The computer-readable medium of claim 15, wherein the method comprises
determining whether a call stack of the webpage modification interface contains an RPCRT4.dll file, and
determining, in response to determining that the call stack contains a RPCRT4.dll file, that the first request received by the webpage modification interface is an external request.
